(19) United States
(12) Patent Application Publication
(10) Pub. No.: US 2019/0032324 A1
(43) Pub. Date: Jan. 31, 2019

(54) SEWER INSPECTION AND/OR MAINTENANCE SYSTEM

(71) Applicant: iPEK International GmbH, Sulzberg (DE)

(72) Inventor: Michael Kress, Kempten (DE)

(21) Appl. No.: 16/041,979

(22) Filed: Jul. 23, 2018

(30) Foreign Application Priority Data
Jul. 25, 2017 (DE) 20 2017 104 428.9

(51) Int. Cl. E03F 7/12; G03B 37/00

(52) U.S. Cl. CPC E03F 7/12; G03B 37/005

(57) ABSTRACT

A sewer inspection and/or maintenance system is provided comprising an inspection and/or maintenance unit and a control and/or display unit, wherein the control and/or display unit is coupled operatively to the inspection and/or maintenance unit via a twisted-pair cable comprising copper. The inspection and/or maintenance unit comprises an imaging unit, which is coupled operatively to a processing unit comprising a digital signal processor (DSP) or an application-specific integrated circuit (ASIC) of the inspection and/or maintenance unit. The processing unit is coupled operatively to the twisted pair cable, and the processing unit is adapted to digitalize and to compress the image data received from the imaging unit to prepare the digitalized and compressed image data for a transmission according to the BroadR-Reach standard, and to transmit the prepared image data according to the BroadR-Reach standard via the twisted pair cable to the control and/or display unit.

### CROSS REFERENCE TO RELATED APPLICATIONS

This application claims priority to German Application No. 20 2017 104 428.9, filed Jul. 25, 2017, the contents of which are incorporated by reference herein.

### TECHNICAL FIELD

The invention relates to a sewer inspection and/or maintenance system comprising an inspection and/or maintenance unit and a control and/or display unit, wherein the inspection and/or maintenance unit is coupled operatively to the control and/or display unit.

### BACKGROUND

For performing pipe or sewer inspections, it is known to use so-called sewer inspection systems, which can be inserted into the pipe or sewage pipe to be inspected, and which may be advanced within the sewage pipe. For maintenance purposes, as cleaning of sewage pipes, it is known to use sewage pipe maintenance systems, which comprise cleaning devices, as high pressure flushing means. The sewer inspection systems as well as the sewer maintenance systems may comprise cameras and/or sensors, by means of which images and videos or various measurement data can be detected during the inspection or during the maintenance.

The captured images, videos, and/or measurement data have to be transmitted to a monitoring means or control and/or display means, which is outside of the pipe or sewer system, where it can be analyzed and, if needed, further processed. For capturing images and videos, high resolution cameras (HD cameras) are increasingly used.

The high resolution images or videos (HD videos) captured by the cameras, hereby, can be transmitted via a coaxial transmission line or a glass fiber line. These lines usually are located within a cable, in which further lines for the voltage supply and/or for the data transmission may be present. With respect to high-resolution cameras (HD cameras), there are very high requirements with respect to quality of the lines so that a high-resolution image can be transmitted or a high-resolution video (HD video) can be transmitted error-free and preferably without judder. The ranges required for sewer inspection or sewer maintenance, however, cannot be realized by these. Moreover, the coaxial transmission lines are expensive, for example, due to the use of coaxial components, and can only be repaired, if needed, with great effort. Glass fiber lines, in turn, practically cannot be repaired by laypersons such that a sewer inspection and/or cleaning company has to interrupt or even cancel the work activities upon a defect of the glass fiber lines.

In both cases (coaxial lines and glass fiber lines), as an aggravating factor, the high speed transmissions are vulnerable to capacity changes in the cable and the like, as these may occur due to deterioration of the cable. In particular, in the harsh environment in sewers, the cables are heavily stressed and are subject to substantially increased wear.

Therefore, it is an object of the present invention to at least partially avoid the disadvantages known from prior art, and to provide a sewer inspection and/or maintenance system, by means of which a reliable data transmission, in particular, of high-resolution videos (HD videos) is enabled over great distances between the inspection and/or maintenance unit and the control and/or display unit.

### SUMMARY

This object may be solved by a sewer inspection and/or maintenance system according to the independent claim. Preferred embodiments and further developments of the invention are defined in the dependent claims.

Accordingly, a sewer inspection and/or maintenance system is provided comprising an inspection and/or maintenance unit and a control and/or display unit, wherein
the control and/or display unit is coupled operatively to the inspection and/or maintenance unit via a twisted-pair cable comprising copper wires,
the inspection and/or maintenance unit comprises an imaging unit, which is coupled operatively to a digital signal processor (DSP) or a processing unit of the inspection and/or maintenance unit comprising an application-specific integrated circuit (ASIC),
the processing unit is coupled operatively to the twisted-pair cable, and
the processing unit is adapted to digitalize and, if needed, compress image data received from the imaging unit, and
to prepare the digitalized and compressed imaging data for a transmission according to the BroadR-Reach standard via the twisted-pair cable.

The imaging data may be high-resolution videos (HD videos) or high-resolution images.

The video signal, thus, is not transmitted in a non-compressed form immediately. Prior to the transmission, the video signal is digitalized and, if needed, compressed, the latter being accomplished by compression methods. The compression and/or digitalization, hereby, is/are carried out by the processing unit such that commercially available HD cameras may be employed.

After the preparation of the image data for a transmission according to the BroadR-Reach standard, the data packets are transmitted according to the BroadR-Reach standard. It has been found that the data packets can be transmitted according to the BroadR-Reach standard via a twisted-pair cable comprising copper cables, and, in fact, on the one hand, with the required speed and bandwidth and, on the other hand, error-free and, in particular, over the ranges required in sewer inspection and sewer maintenance, respectively. Thereby, even high resolution videos (HD videos) can be transmitted in real time and without quality loss by the inspection and/or maintenance unit to the control and/or display unit. Expensive, vulnerable coaxial transmission lines or glass fiber lines which are hard to maintain can be dispensed with whereby, however, transmission rates of up to 1000 Mbit/s can be achieved. Moreover, a twisted-pair cable comprising copper wires is substantially easier to repair compared to coaxial and glass fiber transmission wires such that in case of damage of the cable, a repair on site is possible, and the downtime can be reduced substantially.

Moreover, it has been found that with the use of the BroadR-Reach standard for the data transmission, the high speed transmissions required for the transmission of the videos are substantially less vulnerable with respect to capacity changes or the like. A certain wear of the cable, therefore, does not affect the data transmission. Only, if the wear of the cable exceeds a certain degree, the cable has to be repaired or replaced. Compared to the solutions known from prior art, the cable may be used substantially longer before it has to be repaired or replaced.

As twisted-pair cable, one-, two-, or four-, or multi-pair configurations may be used.

It is particularly advantageous, if the imaging unit comprises a number of imaging means, which respectively are coupled operatively to the processing unit, wherein the processing unit is adapted
to digitalize and to compress the image data received from the imaging means in parallel or quasi-parallel, and to prepare it for a transmission according to the BroadR-Reach standard, and
to transmit the prepared image data from the number of imaging means according to the BroadR-Reach standard in parallel, i.e., simultaneously via the twisted-pair cable to the control and/or display unit.

Thereby, high-resolution video cameras, for example, an HD camera directed forwards or directed backwards, may be attached to an inspection unit (e.g., to a carriage). Thereby, it is possible to observe the sewer pipe during an inspection process simultaneously from different viewpoints, enabling a more efficient inspection. Moreover, errors which may occur during the interpretation of the video images are reduced, because the images of the camera being directed forwards and being directed backwards may be observed simultaneously, thus, chronologically, the images are related to each other correctly.

Further, it is advantageous, if the inspection and/or maintenance unit comprises at least one sensor unit, which is coupled operatively to the processing unit, wherein the processing unit is adapted to prepare the sensor data for a transmission according to the BroadR-Reach standard, and to transmit the prepared sensor data according to the BroadR-Reach standard via the twisted-pair cable to the control and/or display unit.

Hereby, it is advantageous, if the processing unit is adapted to transmit the prepared sensor data to the control and/or display unit in parallel to the image data.

A parallel or simultaneous transmission of several high-resolution videos and sensor data via a twisted-pair cable and over large distances is only possible due to the implementation of the BroadR-Reach standard.

The control and/or display unit may comprise a transceiver unit comprising a digital signal processor (DSP) or an application-specific integrated circuit (ASIC), which is coupled to the twisted-pair cable operatively, wherein the transceiver unit is adapted to transmit data according to the BroadR-Reach standard via the twisted-pair cable to the processing unit, and to receive from the processing unit. Thereby, a bidirectional data transmission between the inspection and/or maintenance unit and the control and/or display unit is enabled in a particularly advantageous manner. Thereby, also control data and/or monitoring data may be transmitted from the control and/or display unit to the inspection and/or maintenance unit.

Further, it is preferable, if the transceiver unit, the processing unit, and the twisted-pair cable are adapted to transmit data in full duplex operation. Thereby, the full controllability of the inspection and/or maintenance unit can be ensured during a transmission of one or more high-resolution videos, without the video transmission having to be interrupted. Thereby, also e.g., video data may be transmitted in one direction and control data may be transmitted in the other direction simultaneously.

The imaging means may comprise at least one HD camera for capturing high-resolution video images.

The inspection and/or maintenance unit may comprise a carriage and/or a pushing system.

According, it is possible to transmit several high-resolution videos in parallel or simultaneously with high quality in real time over long distances via a twisted-pair cable comprising copper wires.

### BRIEF DESCRIPTION OF THE DRAWINGS

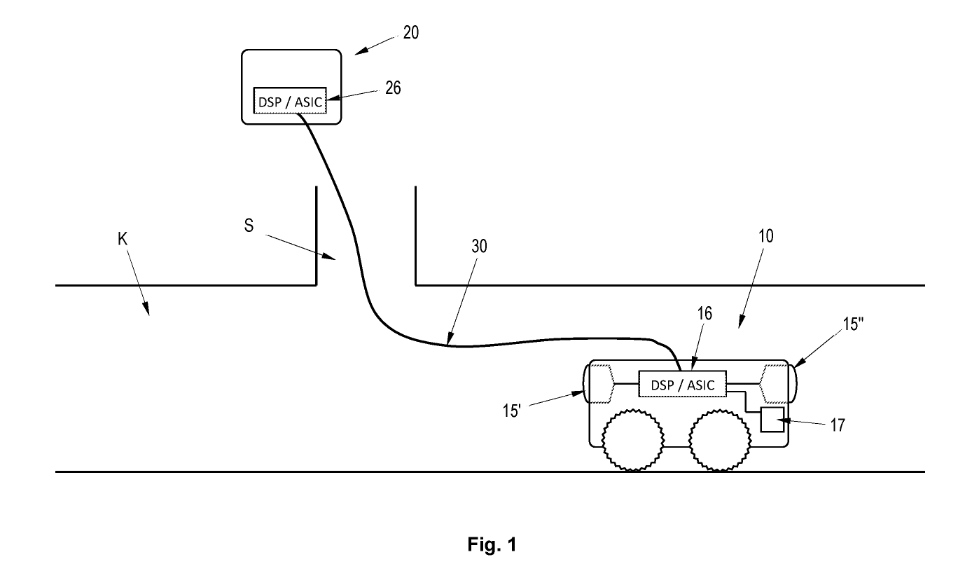

Further details and features of the invention as well as concrete, in particular, preferred embodiments of the invention can be derived from the following description in connection with the drawing, wherein the only FIG. 1 is a schematic illustration of the sewer inspection and/or maintenance system.

### DETAILED DESCRIPTION

The only FIG. 1 shows a schematic illustration of a sewer inspection and/or maintenance system comprising an inspection and/or maintenance unit 10 and a control and/or display unit 20.

The inspection and/or maintenance unit 10, here, is configured as so called carriage system, wherein several camera systems 15′, 15′ and sensors 17 are arranged on the carriage. Also, manipulation means or flushing nozzles or flushing heads may be arranged at the carriage.

The inspection and/or maintenance unit 10, however, may also be configured as a pushing system, which may be pushed into the sewer pipe L by means of a pushing rod.

Independently of the inspection and/or maintenance unit 10 being configured as carriage system or as pushing system, the inspection and/or maintenance unit 10 comprises one or more camera systems 15′, 15″, which may be configured as high-resolution video cameras. With respect to the inspection and/or maintenance unit 10 shown in FIG. 1, the camera system 15′ may be configured as a camera which is directed forwards. Thereby, the rear as well as the front portion of the sewer pipe may be monitored simultaneously during a sewer inspection. Also, it is possible to provide more than two camera systems, wherein the inspection and/or maintenance system allows for viewing the images, in particular, high-resolution videos captured by the several camera systems simultaneously, because the videos captured by the several camera systems can be transmitted in parallel to a control and/or display unit 20.

The inspection and/or maintenance units 10 being located in the sewer pipe K, is coupled operatively via a cable 32 to a control and/or display unit 20 arranged outside of the sewer pipe, wherein the cable 30 is guided out of the sewer pipe K via a duct S.

The transmission of the image data or video data is carried out via the cable 30. Further, also the sensor data provided by the sensors 17 may be transmitted via this cable 30.

Vice versa, also control data, monitoring data, or other data may be transmitted via the cable 30 from the control and/or display unit 20 to the inspection and/or maintenance unit 10.

The transmission of the data between the control and/or monitoring unit 20 and the inspection and/or maintenance unit 10 may be executed in full duplex operation.

The cable 30 is a twisted-pair cable comprising copper wires. Thereby, data cables for the use in sewer inspection and/or maintenance systems may be provided cost efficiently. Moreover, such cables can be repaired easily compared to glass fiber cables or coaxial transmission cables. A further advantage of such cables compared to glass fiber cables or coaxial transmission cables is the low weight, being particularly advantageous, if long sewer pipe portions are to be inspected or are to be maintained.

The inspection and/or maintenance unit 10 comprises a processing unit 16, which comprises a digital signal processor (DSP) or an application-specific integrated circuit (ASIC). The processing unit 16, on the one hand, is coupled operatively to the camera systems 15′, 15″ and/or to the sensor means 17. On the other hand, the inspection and/or maintenance unit 10 is coupled operatively to the cable 30 or is coupled operatively to the control and/or display unit 20 via the cable 30.

The processing unit 20 receives the image data of the camera systems for further processing. If the images or videos are provided as analog signals by the camera systems, the processing unit 16 converts these signals into digital image data or digital video data. Further, the processing unit 16 may compress the digital image data/video data, for which procedure compression methods known per se can be used.

The sensor signals provided by the sensor means 17 are, if needed, digitalized and compressed such that digital and compressed sensor data is available for the transmission. Depending on the amount of data of the sensor data, also a compression of the sensor data may be dispensed with.

Prior to the digital and compressed image data (and, if needed, the digital sensor data) being transmitted via the cable 30 to the control and/or display unit 20, it is prepared such that it can be transmitted according to the BroadR-Reach standard via the cable 30. This means that the data (image data and/or sensor data) is prepared such that it is transmitted as data packets such that the data packets may be put together correctly again by the recipient (i.e., by the control and/or display unit 20) after the transmission. If needed, i.e, for several images or videos and/or sensor data having to be transmitted simultaneously, a unique identifier has to be added to each data packet. The recipient may then assign the data packets to the respective image, video, or sensor date, on the basis of this identifier.

After the preparation of the data (image data and/or sensor data), the corresponding data packets are transmitted according to the BroadR-Reach standard via the cable 30 to the control and/or display unit 20. The control and/or display unit 20 comprises a transceiver unit 26, which is coupled operatively to the cable 30. The transceiver unit 26, in turn, may also comprise a digital signal processor (DSP) or an application-specific integrated circuit (ASIC) and may be adapted to receive the data transmitted via the cable 30 according to the BroadR-Reach standard. The transceiver unit 26 then prepares the data packets received such that again image data, video data, or sensor data is produced, which then, if needed, may be decompressed.

The video data may be transmitted by the processing unit 16 of the inspection and/or maintenance unit 10 as a so-called video stream such that the user of the system is provided with a live view of the corresponding camera. In this case, the control and/or display unit may prepare the received data packets of the video data such that it also provides a video stream for being output to a monitor.

By means of the present inspection and/or maintenance system, according to which the digital data is transmitted by means of the BroadR-Reach standard via a twisted-pair cable comprising copper wires, on the one hand, very large bandwidths may be achieved, as they are required for the simultaneous transmission of several high-resolution videos, and on the other hand, the costs for the transmission system can be kept low. Thus, the so-called live view of a sewer pipe section is possible from different perspectives.

Further, it has been found that the twisted-pair cable comprising the copper wires may be subject to relatively high wear without resulting in impairments of the data transmission. This means that the cables may be used substantially longer before having to be replaced, thus on the one hand, reducing the costs and, on the other hand, reducing the set-up times or down times required for cable replacement.

A further important advantage of the present inspection and/or maintenance system is that the weight of the cable may be reduced substantially compared to glass fiber cables and coaxial transmission cables, this, in turn, leading to substantially longer sewer pipe sections being able to be reached for example, by a carrier which, before the system is moved to the next sewer pipe duct. An inspection or maintenance of a sewer pipe, thereby, may be carried out in a substantially more efficient manner.

### REFERENCE NUMERALS

10 inspection and/or maintenance unit
15′, 15″ camera systems
16 processing unit
17 sensors
20 control and/or display unit
26 transceiver unit
30 cable (twisted pair cable comprising copper wires)
K sewer pipe
S duct

1. A sewer inspection and/or maintenance system comprising an inspection and/or maintenance unit (10) and a control and/or display unit (20), wherein
the control and/or display unit (20) is coupled operatively to the inspection and/or maintenance unit (10) via a twisted-pair cable (30) comprising copper wires,
the inspection and/or maintenance unit (10) comprises an imaging unit (15), which is coupled operatively to a processing unit (16) comprising a digital signal processor (DSP) or an application-specific integrated circuit (ASIC) of the inspection and/or maintenance unit (10),
the processing unit (16) is coupled operatively to the twisted pair cable (30), and
the processing unit (16) is adapted
to digitalize and to compress the image data received from the imaging unit (15),
to prepare the digitalized and compressed image data for a transmission according to the BroadR-Reach standard, and
to transmit the prepared image data according to the BroadR-Reach standard via the twisted-pair cable (30) to the control and/or display unit (20).

2. The sewer inspection and/or maintenance system of claim 1, wherein the imaging unit (15) comprises a number of imaging means (15′, 15″), which respectively are coupled operatively to the processing unit (16), and wherein the processing unit (16) is adapted
to digitalize and to compress the image data received from the number of imaging means (15′, 15″) in parallel or quasi-parallel, and to prepare it for a transmission according to the BroadR-Reach standard, and
to transmit the prepared image data from the number of imaging means (15′, 15″) according to the BroadR-Reach standard in parallel via the twisted pair cable (30) to the control and/or display means (20).

3. The sewer inspection and/or maintenance system of claim 1, wherein the inspection and/or maintenance unit (10) comprises at least one sensor unit (17), which is coupled operatively to the processing unit (16), and wherein the processing unit (16) is adapted to prepare the sensor data for a transmission according to the BroadR-Reach standard, and to transmit the prepared sensor data according to the BroadR-Reach standard via the twisted pair cable (30) to the control and/or display unit (20).

4. The sewer inspection and/or maintenance system of claim 3, wherein the processing unit (16) is adapted to transmit the prepared sensor data in parallel to the image data to the control and/or display unit (20).

5. The sewer inspection and/or maintenance system of claim 1, wherein the control and/or display unit (20) comprises a transceiver unit (26) comprising a digital signal processor (DSP) or an application specific integrated circuit (ASIC), which is coupled operatively to the twisted pair cable (30), and wherein the transceiver unit (26) is adapted to transmit data, in particular, control and/or monitoring data according to the BroadR-Reach standard via the twisted-pair cable (30) to the processing unit (16).

6. The sewer inspection and/or maintenance system of claim 5, wherein the transceiver unit (26), the processing unit (16), and the twisted-pair cable (30) are adapted to transmit data in full duplex operation.

7. The sewer inspection and/or maintenance system of claim 1, wherein the imaging means (15′, 15″) comprise at least one HD camera for capturing high-resolution video images.

8. The sewer inspection and/or maintenance system of claim 1, wherein the inspection and/or maintenance unit (10) comprises a carriage and/or a pushing system.
